(19) United States
(12) Patent Application Publication
(10) Pub. No.: US 2005/0190982 A1
(43) Pub. Date: Sep. 1, 2005

(54) Image reducing device and image reducing method

(75) Inventor: Keiichi Tsumura, Hyogo (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 10/995,331

(22) Filed: Nov. 24, 2004

(30) Foreign Application Priority Data
Nov. 28, 2003 (JP) P2003-399323

(51) Int. Cl. G06K 9/36; G06K 9/46; G06K 9/32

(52) U.S. Cl. 382/250; 382/233; 382/298

(57) ABSTRACT

An image reducing device according to the present invention comprises an inverse orthogonal transforming unit for executing an inverse orthogonal transformation to orthogonally transformed image data and thereby transforming the image data into decoded image data, wherein the inverse orthogonal transforming unit decreases number of pixels in response to an image-reducing scale factor at the time of the transformation into the decoded image data so as to reduce the image data.

### FIELD OF THE INVENTION

The present invention relates to an image reducing device and an image reducing method for reducing a size of an image.

### BACKGROUND OF THE INVENTION

As an encoding method of a still image data, JPEG (Joint Photographic Experts Group) is often employed. In a digital still camera, for example, data of a photographed still image is compression-encoded by means of the JPEG method and stored in a memory, and accordingly read from the memory to be thereby decoded and displayed on a liquid crystal display unit or outputted to an external monitoring device.

In general, a size of the liquid crystal display unit in the digital still camera is smaller than a size of the image data read from the memory and decoded. Therefore, the image data is reduced before being displayed.

Conventionally, a variety of devices for reducing the image data have been proposed, an example of which is recited in No. 8-18964 of the Publication of the Unexamined Japanese Patent Applications.

A process of decoding and reducing the image data compression-encoded by means of the JPEG method is described referring to a block diagram of FIG. 10 and a flow chart of FIG. 11.

First, image data, which was compression-encoded by means of the JPEG method, is inputted. Then, header information thereof is analyzed in a header information analyzing unit, a quantization table 5 and a Huffman table 3 are created, the image data is Huffman-decoded with the Huffman table 3 in a Huffman decoding unit 4 and inverse-quantized with the quantization table 5 in an inverse-quantizing unit 6, and further, subjected to an inverse-discrete cosine transformation (IDCT) in an inverse discrete cosine transforming unit 15 and thereby decoded. The image data is temporarily stored in a memory 16 and reduced as a result of a thinning process or the like executed thereto in a reducing zoom unit 17 in response to an image-reducing scale factor which is set by a setting unit not shown.

In the conventional technology, the decoded image data is temporarily stored in the memory 16 and subjected to the thinning process or the like in response to the reducing scale factor to realize the reduction of the image data, wherein the memory 16 and the reducing zoom unit 17 were necessarily provided.

### SUMMARY OF THE INVENTION

Therefore, a main object of the present invention is to cutback a memory and a reducing zoom unit used for image reduction.

An image reducing device according to the present invention comprises an inverse orthogonal transforming unit for performing an inverse orthogonal transformation to orthogonally transformed image data and thereby transform the image data into decoded image data, wherein the inverse orthogonal transforming unit decreases number of pixels in response to an image-reducing scale factor at the time of the transformation into the decoded image data so as to reduce the image data.

An image reducing method according to the present invention comprises an inverse orthogonal transforming step for performing the inverse orthogonal transformation to the orthogonally transformed image data and transforming the image data into the decoded image data, wherein the inverse orthogonal transforming step decreases the number of the pixels in response to the image-reducing scale factor at the time of the transformation into the decoded image data so as to reduce the image data.

According to the present invention, when the orthogonally transformed image data is subjected to the inverse orthogonal transformation to be thereby transformed into the decoded image data, the image data is reduced through the decrease of the number of the pixels in response to the image-reducing scale factor. Therefore, it becomes unnecessary to temporarily store the image data which was subjected to the inverse orthogonal transformation and perform the thinning process, or the like, thereto.

### BRIEF DESCRIPTION OF THE DRAWINGS

These and other objects as well as advantages of the invention will become clear by the following description of preferred embodiments of the invention with reference to the accompanying drawings, wherein:

FIG. 1 is a block diagram of an image reducing device according to an embodiment of the present invention;

FIG. 2 is a block diagram used for describing image compression by means of JPEG method;

FIG. 3 are illustrations of image data of a same scale factor and a DCT coefficient;

FIG. 4 are illustrations of image data of ½ scale factor and a DCT coefficient;

FIG. 5 are illustrations of image data of ¼ scale factor and a DCT coefficient;

FIG. 6 are illustrations of image data of n/8 scale factor and a DCT coefficient;

FIG. 7 is an illustration of image data used for describing image reduction by ⅓ scale factor;

FIG. 8 is an illustration of image data used for describing reduction by an optional scale factor;

FIG. 9 is a flow chart used for describing an operation of the image reducing device of FIG. 1;

FIG. 10 is a block diagram of an image reducing device according to a conventional technology; and

FIG. 11 is a flow chart flow chart used for describing an operation of the conventional image reducing device.

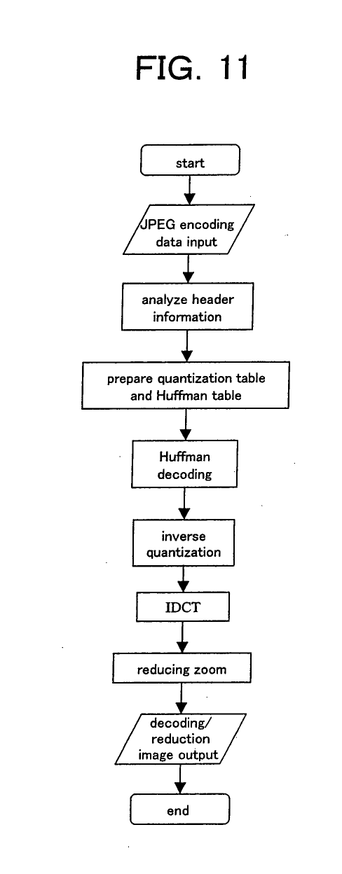

In all these figures, like components are indicated by the same numerals.

### DETAILED DESCRIPTION OF THE PREFERRED EMBODIMENTS

Hereinafter, preferred embodiments of the present invention are described in detail referring to the drawings.

### Embodiment 1

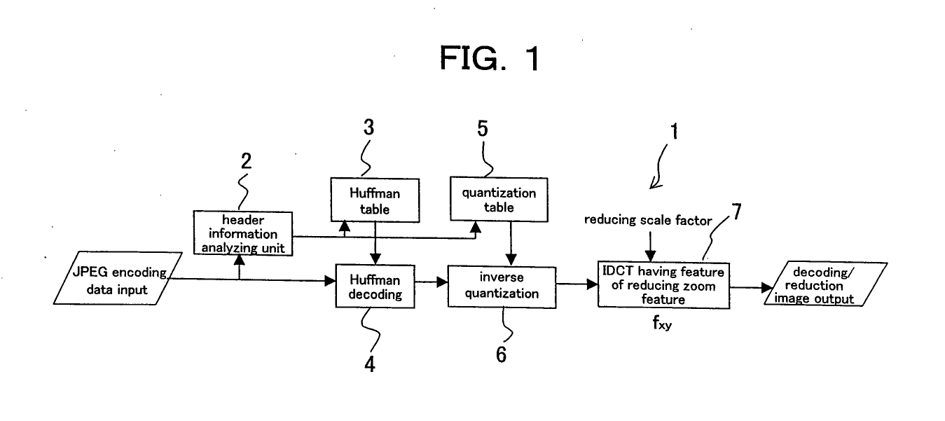

FIG. 1 is a block diagram illustrating a schematic constitution of an image reducing device according to an embodiment of the present invention.

An image reducing device 1 is, for example, incorporated in a digital still camera, and used for purposes such as decoding data of a photographed image which was image-compressed according to JPEG method and stored in a memory not shown and reducing the image so as to display it on a liquid crystal display unit, an external monitoring device or the like.

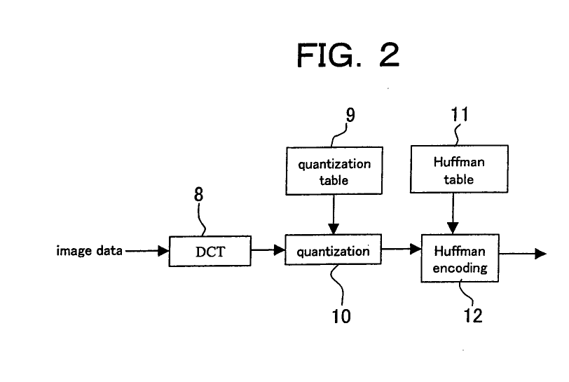

In the JPEG method, in general, the image data is, for example, divided into pixels of 8×8, and, as shown in FIG. 2, subjected to a fast discrete cosine transformation per block in a discrete cosine transforming (DCT) unit 8, quantized with a quantization table 9 in a quantizing unit 10 and Huffman-encoded with a Huffman table 11 in a Huffman encoding unit 12 to be thereby compressed.

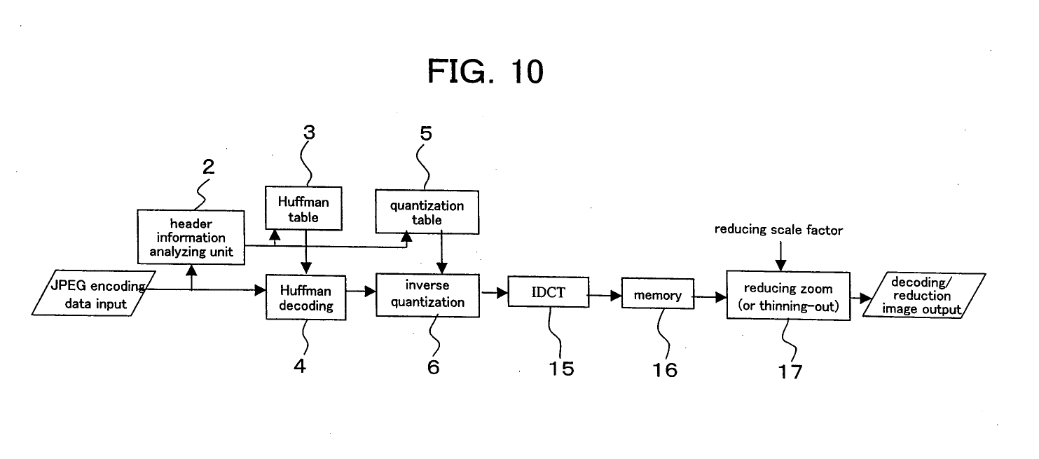

The image reducing device 1 according to the present embodiment comprises, as shown in FIG. 1, a header information analyzing unit 2 for analyzing header information of the image data compression-encoded according to the JPEG method, a Huffman decoding unit 4 for Huffman-decoding the compression-encoded image data with a Huffman table 3 and an inverse quantizing unit 6 for inverse-quantizing the decoded image data with a quantization table 5. The foregoing constitution of the device conforms to that of the conventional device of FIG. 10.

In the present embodiment, an inverse discrete cosine transforming unit 7 for performing an inverse discrete cosine transformation to output data of the inverse quantizing unit 6 is provided with a reducing zoom feature for reducing the image at the same time as performing the inverse discrete cosine transformation in order to cutback the memory and reducing zoom unit used for the image reduction.

More specifically, the inverse discrete cosine transforming unit 7 according to the present embodiment decreases the number of the pixels in response to an image-reducing scale factor provided by a setting unit not shown at the time of performing the inverse discrete cosine transformation for the transformation of the image data and outputs the image data of a reduced size.

Prior to the description of the inverse discrete cosine transformation of the inverse discrete cosine transforming unit 7, below is described the fast discrete cosine transformation (FDCT) and inverse discrete cosine transformation (IDCT) of a same scale factor requiring no image reduction in the foregoing conventional example are described.

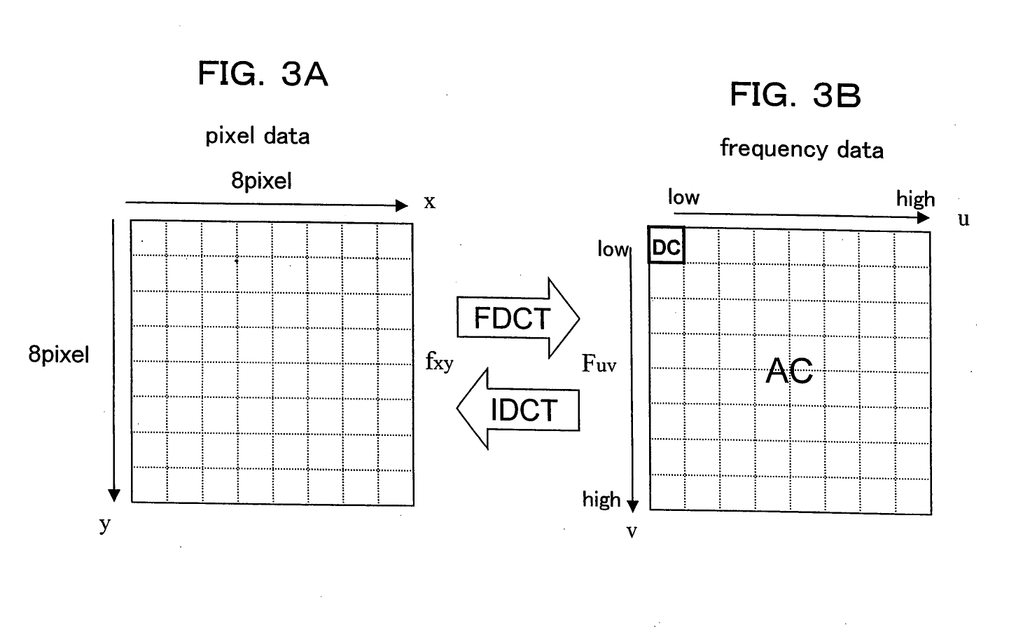

A DCT coefficient F_{UV} of FIG. 3B obtained by executing the fast discrete cosine transformation (FDCT) to a pixel value f_{xy}, which is image data shown in FIG. 3A, is calculated by the following formula 1. Image data F_{xy} obtained by executing the inverse discrete cosine transformation (IDCT) to the DCT coefficient Fᵤᵥ is calculated by the following formula 2.

$$\begin{matrix}[ Formula 1 ] \\ {F}_{uv} = \frac{1}{4} {C}_{u} {C}_{v} {\sum }_{x = 0}^{7} {\sum }_{y = 0}^{7} ( {f}_{xy} - 128 ) cos \frac{( 2 x + 1 ) u π}{16} cos \frac{( 2 y + 1 ) v π}{16} & ( 1 ) \\ [ Formula 2 ] \\ {f}_{xy} = \frac{1}{4} {\sum }_{u = 0}^{7} {\sum }_{v = 0}^{7} {C}_{u} {C}_{v} {F}_{uv} cos \frac{( 2 x + 1 ) u π}{16} cos \frac{( 2 y + 1 ) v π}{16} + 128 & ( 2 )\end{matrix}$$

In the foregoing formulas, an image block to be subjected to the discrete cosine transformation is composed of the pixels of 8 (vertical)×8 (horizontal). x, y=0, 1, . . . 7, and u, v=0, 1, 2 . . . 7. Cᵤ and Cᵥ are obtained by the following formula 3.

In the present case, the pixel value is eight-bit (=0 to 255) data, and the fast discrete cosine transformation is carried out with a central focus placed on 128.

$$[ Formula 3 ] \\ \begin{matrix}{C}_{u} , {C}_{v} = 1 / \sqrt{} 2 ( u , v = 0 ) \\ = 1 ( u , v \neq 0 )\end{matrix} \qquad ( 3 )$$

The DCT coefficient of FIG. 3B is frequency-converted frequency data showing a lower frequency element toward the upper left and a higher frequency element toward the lower right both vertically and horizontally.

In the inverse discrete cosine transforming unit 7 according to the present embodiment, the inverse discrete cosine transformation is carried out, not based on the foregoing formula 2, but based on a formula in response to the image-reducing scale factor so that the image is reduced simultaneously with the inverse discrete cosine transformation.

First is described the case in which vertical and horizontal sizes of the image are reduced by n/8 times (n is an integer) which is a required reducing scale factor.

In the foregoing case, the DCT coefficient shown in FIG. 3B as the image data to which the fast discrete cosine transformation is executed is subjected to the inverse discrete cosine transformation by the following formula 4 in the inverse discrete cosine transforming unit 7 so that the image data f_{xy} reduced by n/8 times is obtained providing that x, y=0, 1, . . . n−1.

$$[ Formula 4 ] \\ {f}_{xy} = \frac{1}{4} {\sum }_{u = 0}^{7} {\sum }_{v = 0}^{7} {C}_{u} {C}_{v} {F}_{uv} cos \frac{( 2 x + 1 ) u π}{2 n} cos \frac{( 2 y + 1 ) v π}{2 n} + 128 \qquad ( 4 )$$

A cos function in an operation of the inverse discrete cosine transformation according to the present embodiment is represented by, not the following formula 5 as in the conventional technology, but the following formula 6

$$\begin{matrix}[ Formula 5 ] \\ cos \frac{( 2 x + 1 ) u π}{16} cos \frac{( 2 y + 1 ) v π}{16} & ( 5 ) \\ [ Formula 6 ] \\ cos \frac{( 2 x + 1 ) u π}{2 n} cos \frac{( 2 y + 1 ) v π}{2 n} & ( 6 )\end{matrix}$$

To be more specific, a denominator in an angle of the cos function is changed from 16 to 2n in response to the reducing scale factor.

Thus, when the angle of the cos function is changed, the image data corresponding to the number of the pixels in compliance with the reducing scale factor, that is the decreased image data whose number of pixels is reduced can be obtained. Therefore, it becomes unnecessary to temporarily store the image data after the execution of the inverse discrete cosine transformation thereto and execute a thinning process or the like to the image data, which was demanded in the conventional technology. The reduced image data can be thus directly obtained.

Below are described a few specific examples of the image reduction.

1. Reduction by ½ times

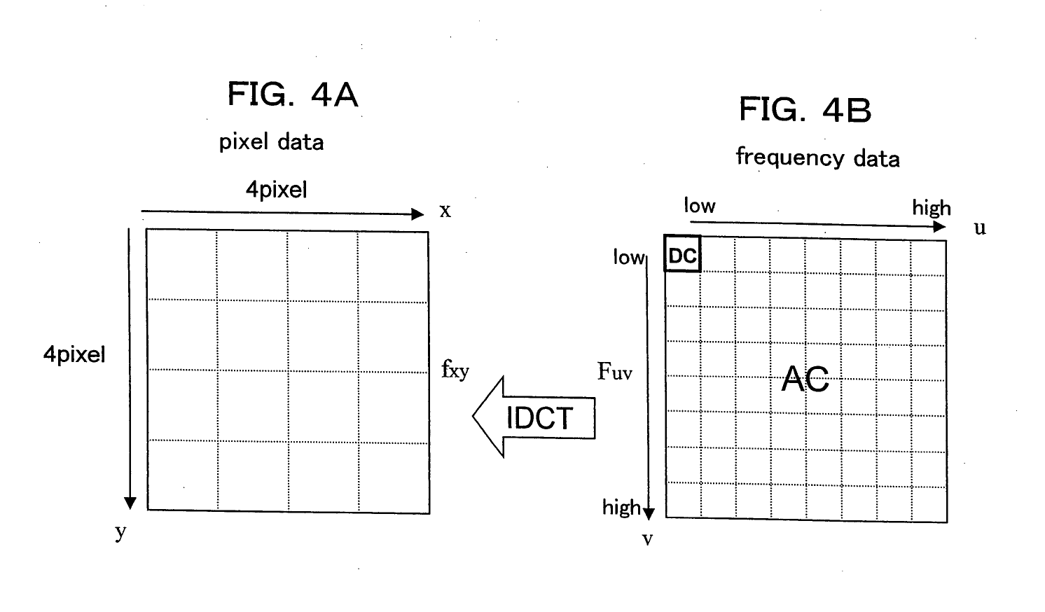

FIG. 4 show the case of reduction by ½ ( 4/8) times, wherein FIG. 4B shows a DCT coefficient (frequency data) as the image data which was subjected to the fast discrete cosine transformation as in FIG. 3B, while FIG. 4A shows the image data of ½ times resulting from executing the inverse discrete cosine transformation to the DCT coefficient, and a screen size is enlarged to be identical to that of FIG. 3A.

In the case of the reduction by ½ times, providing that n=4 in the foregoing formula 4, the following formula 7 is provided for a formula of the reverse discrete cosine transformation. Because n=4, x, y=0, 1, 2, 3.

$$[ Formula 7 ] \\ {f}_{xy} = \frac{1}{4} {\sum }_{u = 0}^{7} {\sum }_{v = 0}^{7} {C}_{u} {C}_{v} {F}_{uv} cos \frac{( 2 x + 1 ) u π}{8} cos \frac{( 2 y + 1 ) v π}{8} + 128 \qquad ( 7 )$$

The inverse discrete cosine transformation is carried out in accordance with the formula 7, and the image data of 4×4 pixels reduced by ½ times based on the DCT coefficient of FIG. 4B, which is shown in FIG. 4A, is thereby obtained.

2. Reduction by ¼ Times

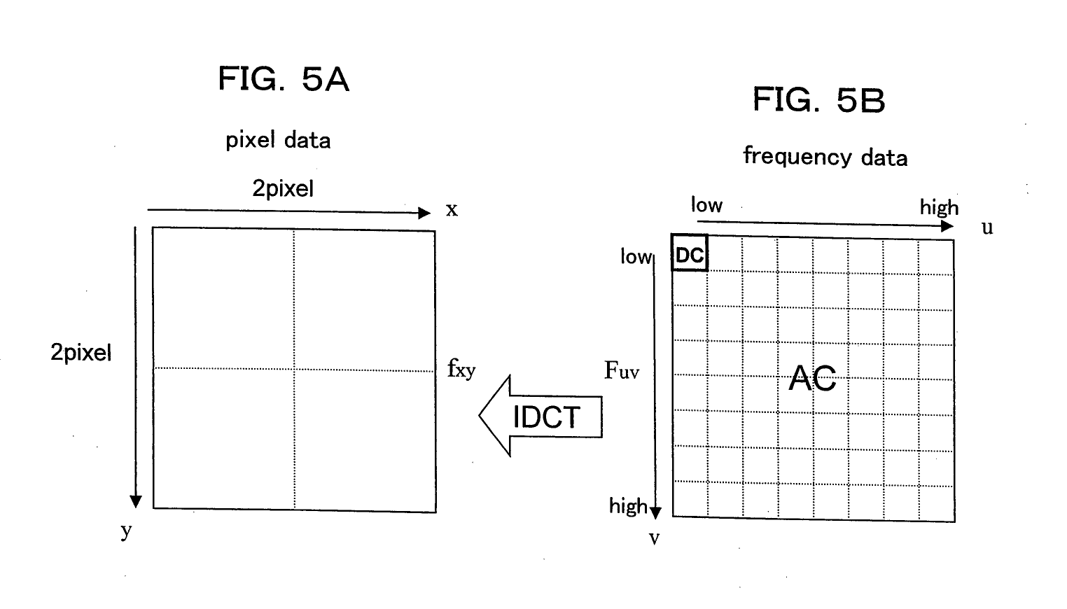

FIG. 5 show the case of reduction by ¼ ( 2/8) times, wherein FIG. 5B shows a DCT coefficient as the image data which was subjected to the fast discrete cosine transformation as in FIG. 3B, while FIG. 5A shows the image data of ¼ times resulting from executing the inverse discrete cosine transformation to the DCT coefficient, and the screen size is enlarged to be identical to that of FIG. 3A.

In the case of the reduction by ¼ times, providing that n=2 in the foregoing formula 4, the following formula 8 is provided for a formula of the reverse discrete cosine transformation. Because n=2, x, y=0, 1.

$$[ Formula 8 ] \\ {f}_{xy} = \frac{1}{4} {\sum }_{u = 0}^{7} {\sum }_{v = 0}^{7} {C}_{u} {C}_{v} {F}_{uv} cos \frac{( 2 x + 1 ) u π}{4} cos \frac{( 2 y + 1 ) v π}{4} + 128 \qquad ( 8 )$$

The inverse discrete cosine transformation is carried out in accordance with the formula 8, and the image data of 2×2 pixels reduced by ¼ times based on the DCT coefficient of FIG. 5B, which is shown in FIG. 5A, is obtained.

3. Reduction by ⅜ Times

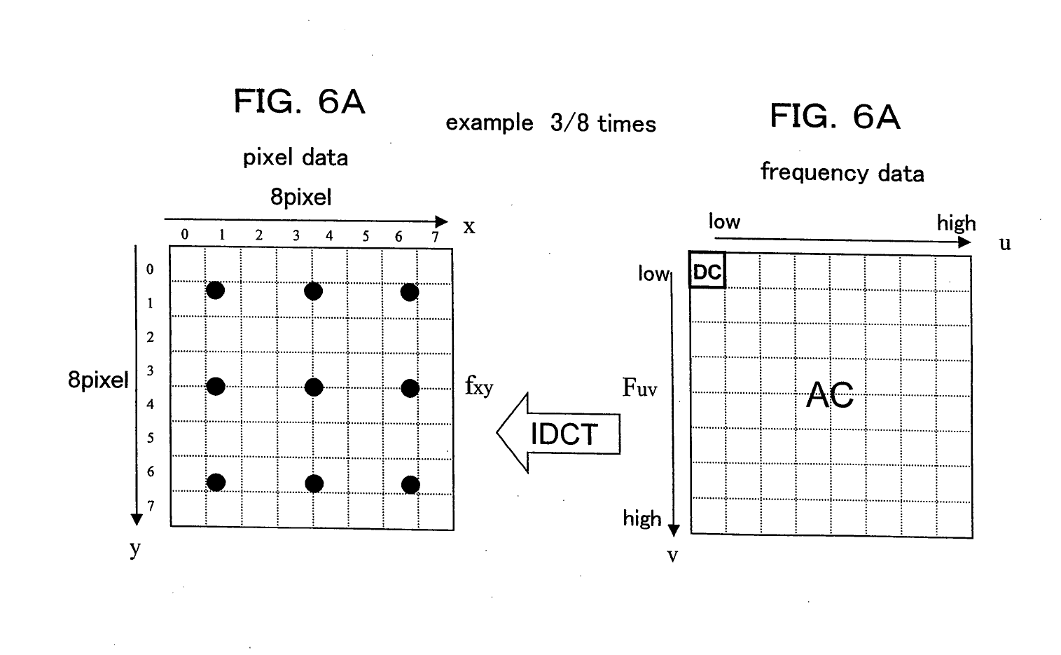

FIG. 6 show the case of reduction by ⅜ times, wherein FIG. 6B shows a DCT coefficient as the image data which was subjected to the fast discrete cosine transformation as in FIG. 3B, while FIG. 6A shows the image data of ⅜ times resulting from executing the inverse discrete cosine transformation to the DCT coefficient, and the screen size is enlarged to be identical to that of FIG. 3A. Black circles in the drawing denote central coordinates for each pixel in vertical and horizontal direction.

In the case of the reduction by ⅜ times, providing that n=3 in the foregoing formula 4, the following formula 9 is provided for a formula of the reverse discrete cosine transformation. Because n=3, x, y=0, 1 and 2.

$$[ Formula 9 ] \\ {f}_{xy} = \frac{1}{4} {\sum }_{u = 0}^{7} {\sum }_{v = 0}^{7} {C}_{u} {C}_{v} {F}_{uv} cos \frac{( 2 x + 1 ) u π}{6} cos \frac{( 2 y + 1 ) v π}{6} + 128 \qquad ( 9 )$$

The inverse discrete cosine transformation is carried out in accordance with the formula 9, and the image data of 3×3 pixels reduced by ⅜ times based on the DCT coefficient of FIG. 6B, which is shown in FIG. 6A, is thereby obtained.

In the foregoing specific examples, the reducing scale factors are n/8 times, however, an optional reducing scale factor, which is 1/z times, can be used in the present invention. z is not necessarily an integer as long as it is a rational number, in other words, as far as z=n/m is satisfied in the case in which n and m are positive integers (providing that n>m).

Specific examples are described below.

4. Reduction by ⅓ Times (z=3)

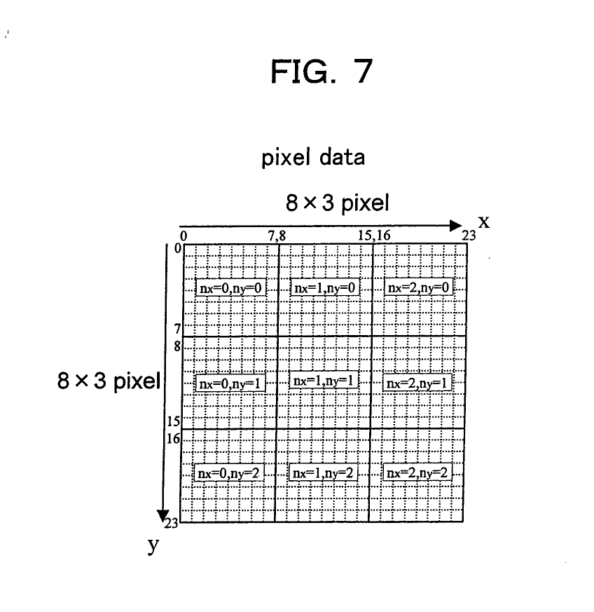

As shown in FIG. 7, when image blocks composed of pixels of (8×3)×(8×3) are a target, and the pixels to be interpolated are (x, y)=(1+3kₓ, 1+3k_{y}), kₓ, k_{y}=0, 1, 2 . . . 7, nₓ and n_{y} (nₓ and n_{y} are integers) satisfying the following formulas 10 and 11 are assigned to the following formula 12 of the inverse discrete cosine transformation. Cᵤ and Cᵥ are obtained by the foregoing formula 3.

$$\begin{matrix}[ Formula 10 ] \\ \frac{2 x - 15}{16} ≦ nx < \frac{2 x + 1}{16} & ( 10 ) \\ [ Formula 11 ] \\ \frac{2 y - 15}{16} ≦ ny < \frac{2 y + 1}{16} & ( 11 ) \\ [ Formula 12 ] \\ {f}_{xy} = \frac{1}{4} {\sum }_{u = 0}^{7} {\sum }_{v = 0}^{7} {C}_{u} {C}_{v} {F}_{uv} {n}_{x} {n}_{y} cos ( \frac{2 x + 1}{16} - nx ) u π cos ( \frac{2 y + 1}{16} - ny ) v π + 128 & ( 12 )\end{matrix}$$

More specifically, as shown in FIG. 7, nₓ=0 in the case of kₓ=0, 1, 2 and n_{y}=0 in the case of k_{y}=0, 1, 2; nₓ=1 in the case of kₓ=3, 4 and n_{y}=1 in the case of kₓ=3, 4; and nₓ=2 in the case of kₓ=5, 6, 7 and n_{y}=2 in the case of k_{y}=5, 6, 7 are assigned to the foregoing formula 12 of the inverse discrete cosine transformation. Then, the DCT coefficient corresponding to the image data of FIG. 7 is subjected to the inverse discrete cosine transformation, and the image data of pixels of 8×8 reduced by ⅓ times can be thereby obtained.

Fᵤᵥ is the DCT coefficient of the block composed of 8×8 pixels. In the case of the number of the pixels being (8×3)×(8×3), there are 3×3 blocks. Accordingly, there are Fᵤᵥ as many as 3×3, which is described as F_{uv nx ny}, and nₓ and n_{y} respectively take a value of nₓ=0, 1, 2 and n_{y}=0, 1, 2.

Thus, when m and n are positive integers (providing that n>m) and z=n/m in the inverse orthogonal transforming step, the reducing scale factor of 1/z times can be realized relative to the orthogonal transformation data, which increases a degree of freedom in the reducing scale factor in the case of the inverse orthogonal transformation.

5. Reduction by ⅔ Times (z=3/2)

As in the earlier example, when image blocks composed of pixels of (8×3)×(8×3) are a target, and the pixels to be interpolated are (x, y)=(1/4+3kₓ/2, 1/4+3k_{y}/2), kₓ, k_{y}=0, 1, 2 . . . 15, nₓ and n_{y} (nₓ and n_{y} are integers) satisfying the formulas 10 and 11 are specifically nₓ=0 in the case of kₓ=0 to 4 and n_{y}=0 in the case of k_{y}=0 to 4; nₓ=1 in the case of kₓ=5 to 10 and n_{y}=1 in the case of kₓ=5 to 10; and nₓ=2 in the case of kₓ=11 to 15 and n_{y}=2 in the case of k_{y}=11 to 15, are assigned to the formula 12 of the inverse discrete cosine transformation to execute the inverse discrete cosine transformation. Thereby, the image data of 16×16 pixels reduced by ⅔ times can be obtained. The reduction by 1/z times, which is an optional scale factor, can be generalized as follows.

6. Reduction by 1/z Times

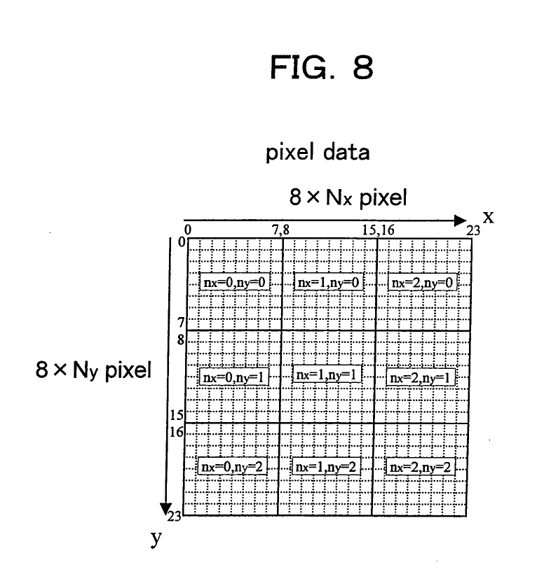

For example, as shown in FIG. 8, image blocks composed of the pixels of (8×Nx)×(8×Ny) are a target, and the pixels to be interpolated are (x, y)=(a+zkₓ, b+zk_{y}), kₓ, k_{y}=0, 1, 2 . . . , nₓ and n_{y} (nₓ and n_{y} are integers) satisfying the foregoing formulas 10 and 11 are assigned to the foregoing formula 12 of the inverse discrete cosine transformation so that the inverse discrete cosine transformation is carried out. Coordinates a, b serve as initial values of the pixels to be interpolated, which are required to show an address of at least one of image blocks composed of the pixels of (8×Nx)×(8×Ny).

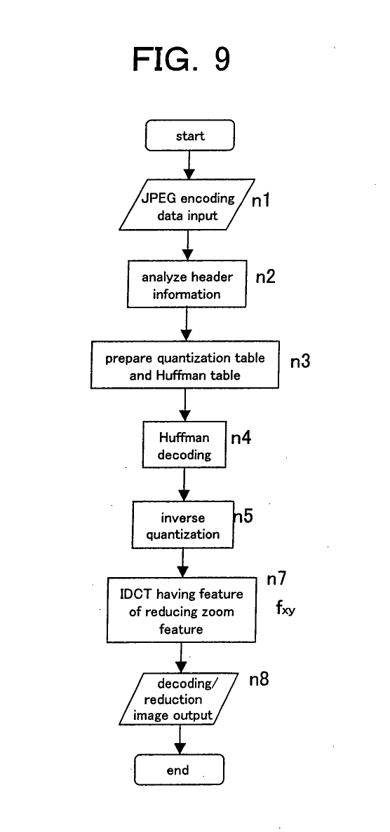

FIG. 9 is a flow chart used for describing an operation of the image reducing device 1 according to the present embodiment.

In the present embodiment, when the compression-encoded image data is inputted (Step n1), header information thereof is analyzed (Step n2), the quantization table 5 and Huffman table 3 are prepared (Step n3), and the image data is Huffman-decoded in the Huffman decoding unit 4 (Step n4) and further, inverse-quantized in the inverse quantizing unit 6 (Step n5).

Next, the image data is subjected to the inverse discrete cosine transformation as described so that the number of the pixels in response to the reducing scale factor can be obtained in the inverse discrete cosine transforming unit 7 having the reducing zoom feature (Step n7), and the decoded reduced image is outputted and the process is thereby terminated (Step n8).

### Embodiment 2

In the foregoing embodiment, the reduced image data is obtained through the operations using all of the DCT coefficients at the time of the inverse discrete cosine transformation. However, as a disadvantage usually occurring in the reduction of the image size, the fold-over of the high-frequency element of the image results in the generation of a noise, which degrades an image quality.

Therefore, in another embodiment of the present invention, the aliasing can be controlled by avoiding the use of high-frequency element of the DCT coefficient at the time of executing the inverse discrete cosine transformation.

More specifically, when the vertical and horizontal sizes of the image is reduced by n/8 times, which is a required reducing scale factor, the following formula 13, in place of the foregoing formula 4, is used to execute the inverse discrete cosine transformation.

$$[ Formula 13 ] \\ {f}_{xy} = \frac{1}{4} {\sum }_{u = 0}^{n - 1} {\sum }_{v = 0}^{n - 1} {C}_{u} {C}_{v} {F}_{uv} cos \frac{( 2 x + 1 ) u π}{2 n} cos \frac{( 2 y + 1 ) v π}{2 n} + 128 \qquad ( 13 )$$

Thus, since the inverse discrete cosine transformation is executed except for the high-frequency element in which u and v are equal to or more than n so that the aliasing can be controlled.

In the case of the reductions by ½ times, ¼ times and ⅜ times, the following formulas 14, 15 and 16 are respectively used in place of the foregoing formulas 7, 8 and 9 to execute the inverse discrete cosine transformation.

$$\begin{matrix}[ Formula 14 ] \\ {f}_{xy} = \frac{1}{4} {\sum }_{u = 0}^{3} {\sum }_{v = 0}^{3} {C}_{u} {C}_{v} {F}_{uv} cos \frac{( 2 x + 1 ) u π}{8} cos \frac{( 2 y + 1 ) v π}{8} + 128 & ( 14 ) \\ [ Formula 15 ] \\ {f}_{xy} = \frac{1}{4} {\sum }_{u = 0}^{1} {\sum }_{v = 0}^{1} {C}_{u} {C}_{v} {F}_{uv} cos \frac{( 2 x + 1 ) u π}{4} cos \frac{( 2 y + 1 ) v π}{4} + 128 & ( 15 ) \\ [ Formula 16 ] \\ {f}_{xy} = \frac{1}{4} {\sum }_{u = 0}^{2} {\sum }_{v = 0}^{2} {C}_{u} {C}_{v} {F}_{uv} cos \frac{( 2 x + 1 ) u π}{6} cos \frac{( 2 y + 1 ) v π}{6} + 128 & ( 16 )\end{matrix}$$

In the case of the reductions by ⅓ times, ⅔ times and 1/z times, the following formulas 17, 18 and 19 are respectively used to execute the inverse discrete cosine transformation in the same manner. In the formula 19, w represents an integral value close to (8/z)−1.

$$\begin{matrix}[ Formula 17 ] \\ {f}_{xy} = \frac{1}{4} {\sum }_{u = 0}^{2} {\sum }_{v = 0}^{2} {C}_{u} {C}_{v} {F}_{uv} cos ( \frac{2 x + 1}{16} - {n}_{x} ) u π cos ( \frac{2 y + 1}{16} - {n}_{y} ) v π + 128 & ( 17 ) \\ [ Formula 18 ] \\ {f}_{xy} = \frac{1}{4} {\sum }_{u = 0}^{4} {\sum }_{v = 0}^{4} {C}_{u} {C}_{v} {F}_{uv} cos ( \frac{2 x + 1}{16} - {n}_{x} ) u π cos ( \frac{2 y + 1}{16} - {n}_{y} ) v π + 128 & ( 18 ) \\ [ Formula 19 ] \\ {f}_{xy} = \frac{1}{4} {\sum }_{u = 0}^{W} {\sum }_{v = 0}^{W} {C}_{u} {C}_{v} {F}_{uv} cos ( \frac{2 x + 1}{16} - {n}_{x} ) u π cos ( \frac{2 y + 1}{16} - {n}_{y} ) v π + 128 & ( 19 )\end{matrix}$$

The embodiments were described in the case of the discrete cosine transformation, however, the present invention is not limited to the discrete cosine transformation and can be applied to a different form of the orthogonal transformation such as Hadamard transformation.

Further, in the foregoing embodiments, the image block is composed of the pixels of 8 (vertical)×8 (horizontal), however, it is needless to say the image block can be based on a different unit.

While there has been described what is at present considered to be preferred embodiments of this invention, it will be understood that various modifications may be made therein, and it is intended to cover in the appended claims all such modifications as fall within the true spirit and scope of this invention.

1. An image reducing device comprising an inverse orthogonal transforming unit for executing an inverse orthogonal transformation to orthogonally transformed image data and thereby transforming the image data into decoded image data, wherein
the inverse orthogonal transforming unit decreases number of pixels in response to an image-reducing scale factor at the time of the transformation into the decoded image data so as to reduce the image data.

2. An image reducing device as claimed in claim 1, wherein
the orthogonal transformation is a discrete cosine transformation, and the inverse orthogonal transforming unit executes an inverse discrete cosine transformation.

3. An image reducing device as claimed in claim 2, wherein
the inverse orthogonal transforming unit uses a cos function which is different to a cos function used in the discrete cosine transformation to execute the inverse discrete cosine transformation.

4. An image reducing device as claimed in claim 2, wherein
the inverse orthogonal transforming unit executes the inverse discrete cosine transformation using data except for a high-frequency element in the image data after the execution of the discrete cosine transformation thereto.

5. An image reducing device as claimed in claim 1, wherein
an entropy decoding unit for entropy-decoding encoded data and an inverse quantizing unit for inverse-quantizing the entropy-decoded data and supplying the inverse orthogonal transforming unit with the inverse-quantized data are further provided.

6. An image reducing device comprising an inverse orthogonal transforming unit for executing an inverse orthogonal transformation to orthogonally transformed image data and thereby transforming the image data into decoded image data, wherein
the inverse orthogonal transforming unit decreases number of pixels by a reducing scale factor of 1/z so as to reduce the image data providing that n and m are positive integers (providing that n>m) and z=n/m at the time of the transformation into the decoded image data.

7. An image reducing device as claimed in claim 6, wherein
the orthogonal transformation is a discrete cosine transformation, and the inverse orthogonal transforming unit executes an inverse discrete cosine transformation.

8. An image reducing device as claimed in claim 7, wherein
the inverse orthogonal transforming unit uses a cos function which is different to a cos function used in the discrete cosine transformation to execute the inverse discrete cosine transformation.

9. An image reducing device as claimed in claim 7, wherein
the inverse orthogonal transforming unit executes the inverse discrete cosine transformation using data except for a high-frequency element in the image data after the execution of the discrete cosine transformation thereto.

10. An image reducing device as claimed in claim 6, wherein
an entropy decoding unit for entropy-decoding encoded data and an inverse quantizing unit for inverse-quantizing the entropy-decoded data and supplying the inverse orthogonal transforming unit with the inverse-quantized data are further provided.

11. An image reducing method comprising an inverse orthogonal transforming step for executing an inverse orthogonal transformation to orthogonally transformed image data and thereby transforming the image data into decoded image data, wherein
number of pixels is decreased in response to an image-reducing scale factor at the time of the transformation into the decoded image data so as to reduce the image data in the inverse orthogonal transforming step.

12. An image reducing method as claimed in claim 11, wherein
the orthogonal transformation is a discrete cosine transformation, and an inverse discrete cosine transformation is executed in the inverse orthogonal transforming step.

13. An image reducing method as claimed in claim 12, wherein
a cos function which is different to a cos function used in the discrete cosine transformation is used to execute the inverse discrete cosine transformation in the inverse orthogonal transforming step.

14. An image reducing method as claimed in claim 12, wherein
the inverse discrete cosine transformation is executed using data except for a high-frequency element in the image data after the execution of the discrete cosine transformation thereto in the inverse orthogonal transforming step.

15. An image reducing method as claimed in claim 11, wherein
an entropy decoding step for entropy-decoding encoded data and an inverse quantizing step for inverse-quantizing the entropy-decoded data and supplying the inverse orthogonal transforming step with the inverse-quantized data are further provided.

16. An image reducing method comprising an inverse orthogonal transforming step for executing an inverse orthogonal transformation to orthogonally transformed image data and thereby transforming the image data into decoded image data, wherein
number of pixels is decreased by a reducing scale factor of 1/z so as to reduce the image data providing that n and m are positive integers (providing that n>m) and z=n/m at the time of the transformation into the decoded image data in the inverse orthogonal transforming step.

17. An image reducing method as claimed in claim 16, wherein
the orthogonal transformation is a discrete cosine transformation, and an inverse discrete cosine transformation is executed in the inverse orthogonal transforming step.

18. An image reducing method as claimed in claim 17, wherein
a cos function which is different to a cos function used in the discrete cosine transformation is used to execute the inverse discrete cosine transformation in the inverse orthogonal transforming step.

19. An image reducing method as claimed in claim 17, wherein
the inverse discrete cosine transformation is executed using data except for a high-frequency element in the image data after the execution of the discrete cosine transformation thereto in the inverse orthogonal transforming step.

20. An image reducing method as claimed in claim 16, wherein
an entropy decoding step for entropy-decoding encoded data and an inverse quantizing step for inverse-quantizing the entropy-decoded data and supplying the inverse orthogonal transforming step with the inverse-quantized data are further provided.
